(19) United States
(12) Patent Application Publication
(10) Pub. No.: US 2008/0299279 A1
(43) Pub. Date: Dec. 4, 2008

(54) Calcium fortification of food powders

(75) Inventors: Vicki Brewer, Coon Rapids, MN (US); Diane Kussy, New Brighton, MN (US); Jason Eckert, Forest Lake, MN (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: Land O'Lakes, Inc., Arden Hills, MN (US)

(21) Appl. No.: 11/893,478

(22) Filed: Aug. 16, 2007

Related U.S. Application Data
(60) Provisional application No. 60/933,095, filed on Jun. 4, 2007.

(51) Int. Cl. A23C 9/16; A23C 19/00

(52) U.S. Cl. 426/582; 426/588

(57) ABSTRACT

Calcium fortified dairy powders are produced using spray drying methods. The spray drying method includes adding a calcium supplement to dairy powder in a slurry tank. The slurry with the calcium supplement and the dairy powder is heated and further processed. The processed slurry is spray dried to form a powder. The method can also include allowing the powder to fall onto a fluid bed wherein additional moisture is removed. The methods described herein use a seaweed calcium.

### CROSS-REFERENCE TO RELATED APPLICATION

The present application is based on and claims the benefit of U.S. provisional patent application Ser. No. 60/933,095, filed on Jun. 4, 2007, the content of which is hereby incorporated by reference in its entirety.

### BACKGROUND OF THE INVENTION

Calcium fortification of foodstuffs is a well recognized means of supplementing the calcium intake of the general population. Inadequate levels of calcium in the diets of individuals has been attributed to a number of health issues, including osteoporosis. As a public health issue, the significance of increasing calcium content of foodstuffs has become more critical with the increased incidence of osteoporosis.

Addition of minerals, particularly calcium, to foodstuffs generally has been known to lead to decreased quality and enjoyment of the food. Calcium fortification has been known to reduce the organoleptic properties of the food, generally, leaving a chalky mouthfeel.

In PCT publication WO 00/25602 a very pure form of corallinaceae was used as a source of calcium to manufacture solid and semi-solid foodstuffs. Aquamin® is a source of calcium derived from processing calcified seaweeds Phymatolithon and Lithothamnion and has been marketed by Marigot Ltd. for use in food applications (Dr. S Lawlor, Innovations in Food Technology, May 2003).

Calcium derived from seaweed has been included in foods such as pasta, ice creams and other fat based products such as chocolate and dairy spreads. It has also been incorporated into beverages such as orange juice. The incorporation of calcium derived from seaweed into foods has used methods of emulsification in an oil or fat phase or by the use of a carbohydrate (sugar) water phase.

Calcium derived from seaweed, however, has not been used in the area of dairy powders. Previous methods of calcium fortification of dairy powders have added calcium carbonate by dry blending into the dairy powders similar to the methods used for beverages. These dairy powders, however, imparted a chalky mouthfeel even at low levels of incorporated calcium.

### SUMMARY OF THE INVENTION

Spray drying methods and systems are described for producing calcium fortified dairy powders. The spray drying method includes adding a calcium source to a slurry that includes dairy powder in a slurry tank. The slurry with the calcium source and the dairy powder is heated. The heated slurry can then be transferred to a surge tank. The contents of the surge tank are further processed by pumping the slurry through a high pressure pump and homogenizing by passing through a homogenizer. The slurry is sprayed using nozzles and dried in a dryer to form a powder. The method can also include allowing the powder to fall onto a fluid bed wherein additional moisture is removed and partially cooling the powder. The methods described herein use a calcium source that has a porous structure. In preferred embodiments, the calcium source is derived from seaweed and in more preferred embodiments, Aquamin®F is used as the calcium source.

In another embodiment, the present invention also includes a method for incorporating calcium into a food powder. The method comprises adding food powder and a calcium source to a slurry in a slurry tank and processing the slurry for atomization. The slurry is spray dried using nozzles to form a powder wherein each serving of food powder comprises greater than about 5% of the recommended daily intake of calcium.

The present invention also includes a food powder comprising spray dried particles of calcium and dairy powder wherein the calcium source has a porous, lattice type structure. In preferred embodiments, the food powder is a dairy powder with Aquamin®F as the calcium source.

### BRIEF DESCRIPTION OF THE DRAWINGS

FIG. 1 is a flow diagram illustrating an overall process for spray dried dairy powders fortified with calcium.

### DETAILED DESCRIPTION OF ILLUSTRATIVE EMBODIMENTS

The present invention generally relates to fortification of food powders and, more specifically, to calcium fortification of dairy powders. Food powders, particularly dairy powders, made using the methods described herein contain high levels of calcium and desirable organoleptic properties. Such a combination of properties in the food powders of the present invention were unanticipated given the propensity of food powders to develop a chalky, gritty mouthfeel even at low calcium levels.

The methods generally involve incorporating a calcium source with dairy powder at a slurry stage. The slurry may be further processed prior to spray drying. The spray drying of the slurry includes atomization through nozzles and drying the atomized particles, preferably in a tower spray dryer. The dried particles may be subjected to further moisture removal by passage over a fluid bed. This process can result in a dairy powder with superior organoleptic properties that is fortified with calcium. In preferred embodiments, a serving size of the dairy powder includes between about 5% and about 30% of the recommended daily intake (RDI) of calcium mineral. The RDI of calcium mineral is generally about 1000 milligrams for an adult. Higher RDI of calcium may also be found in the literature. The percentage of RDI of calcium stated herein is based on a RDI of 1000 milligrams.

The calcium source or supplement used for fortification in the methods of the present invention has a porous, lattice type structure that results in a high specific surface area. Preferably, the calcium source is derived from seaweed. Calcium derived from other sources and having the porous structure is also within the scope of this invention. In particular, calcium derived from calcified seaweeds Phymatolithon and Lithothamnion are preferable. Another preferable source of calcium is from seaweed found in the seabed off the Southwest coast of Ireland. One particular seaweed calcium source preferable in the present methods is Aquamin®F brand of calcium which is supplied by Marigolt Ltd. Aquamin®F's porous, lattice type structure is particularly amenable for use with dairy powders in the methods of the present invention. Aquamin®F has a porous structure resulting in a high specific surface (40 m²/gm vs. 3.9 m²/gm for calcium carbonate) which can yield a smooth texture with a neutral taste that is non-chalky or sandy. The calcium sources used in the methods can contain a variable amount of the calcium mineral. Preferably, the calcium source contains between about 25% calcium mineral to about 50% calcium mineral, and more preferably the calcium source contains between about 30% calcium mineral to about 35% calcium mineral.

Food powders produced by the methods described herein are generally dairy powders. Non dairy powders that are amenable to spray drying are also within the scope of this invention. The spray drying methods described here are amenable to producing superior dairy powders fortified with high levels of calcium. In preferred embodiments, the dairy powders fortified with calcium are cheese powders. The powders produced by the spray drying method are superior for use in making sauces, for example, cheese sauces for use with pasta, rice and the like. Sauces made with the present dairy powders have superior mouthfeel and are less chalky.

In one embodiment, the method includes adding seaweed calcium to a slurry tank that includes dairy powders. The slurry in the slurry tank can also include other ingredients. These ingredients can include, but are not limited to, fillers, acidulants, flavors, emulsifiers and the like. Slurry tanks are well known in the art and generally include large tanks designed to hold foodstuffs. Mixing of ingredients, for example, can be accomplished in slurry tanks. The amount of the calcium source added to the slurry can vary. The amount of calcium source added can be, for example, between about 5% by weight to between about 40% by weight of the dairy powder. In one preferred embodiment, the calcium source added is between about 7% by weight and about 12% by weight of the dairy powder.

The slurry in the slurry tank that includes the calcium source and dairy powder can be further processed. These processes generally aid in improving the incorporation and/or homogenization of calcium with the dairy powders. The slurry in the slurry tank is generally heated. The slurry is preferably heated to between about 100° F. and about 200° F. More preferably, the slurry is heated to between about 140° F. and about 170° F.

The heated slurry may be further processed for preparation for atomization. Further processes may include, for example, transfer of the slurry to a surge tank. The slurry can be processed through a high pressure pump and may also be homogenized through the use of a homogenizer. Any or all of the processes described here may be applied to the slurry from the slurry tank. In one preferred embodiment, the processing of the slurry includes heating the slurry then transferring to a surge tank, to a high pressure pump and to a homogenizer.

The calcium and dairy powder slurry, preferably after being processed, is spray dried. Spray drying includes atomizing slurry particles using nozzles and drying the particles. The spraying of the slurry through the nozzles coatomizes the calcium and dairy powder particles. The atomized particles are then dried, preferably in a tower spray dryer. Other types of dryers may also be used to dry the atomized particles. Powder from the dryer may be further treated by allowing the powder to fall onto a fluid bed. Additional moisture is removed from the powder by allowing the powder to fall onto the fluid bed. Fluid beds are known in the art and described, for example, in U.S. Pat. No. 5,006,204 to Jensen. The dairy powder from the fluid bed may be cooled further. Upon cooling, the dairy powder may be sifted. The sifter, for example, can be a vibrating sifter. The dairy powder, after sifting can be packaged as desired.

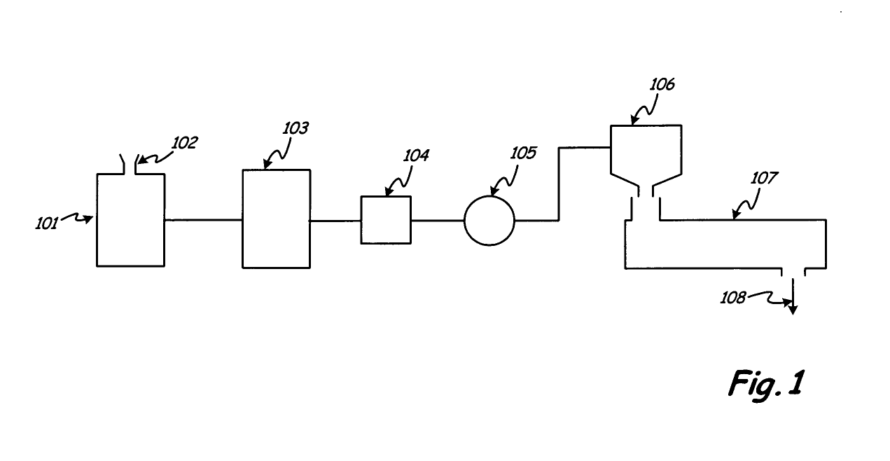

A calcium source and dairy powder are provided in slurry tank 101 through slurry tank inlet 102 as illustrated in FIG. 1. The slurry in slurry tank 101 is heated and transferred to a surge tank 102. The slurry is further processed through high pressure pump 104 and homogenizer 105. The homogenized slurry is then atomized by spray dryer 106. The particles are further dried over fluid bed 107 to remove additional moisture. The calcium fortified dairy powder leaving fluid bed outlet 108 are cooled and packaged. FIG. 1 illustrates one specific embodiment and variations of this embodiment are within the scope of this invention.

It is a specific advantage of the present invention that spray drying a slurry of a dairy powder and a calcium source with a porous structure results in a homogenous mixture of particles that are capable of imparting a smooth texture upon preparation and ingestion of the product. Sensory panels have indicated that both flavor and texture of the dairy powders made using the methods described herein are surprisingly similar to control products made without added calcium. It was expected that the organoleptic properties of dairy powders with added calcium would be chalky, gritty and pasty, especially at the higher levels of calcium used here. Dairy powders supplemented with calcium prepared by spray drying as described herein contain a more homogenous mixture that can impart a smooth texture unlike prior art products produced by dry blending calcium carbonates into powders.

The dairy powders produced using the methods described herein have a significant amount of calcium mineral incorporated into the dairy powder. A single serving size of dairy powder is generally about 3 grams. Variations on the size of a single serving of dairy powder are also within the scope of this invention. A single serving of a food powder is generally about 3 grams. Variations on the size of a single serving of food powder is also within the scope of the invention. In one embodiment, a single serving of the dairy powder contains at least about 5% of the RDI of calcium In another embodiment, one serving of the powder comprises at least 10% of the RDI of calcium. In other embodiments, one serving of the powder comprises at least 20% of the RDI of calcium. In other embodiments, one serving of the powder comprises at least 30% of the RDI of calcium. In more preferred embodiments, a single serving of the dairy powder contains between about 8% and about 10% of the RDI of calcium. In an exemplary embodiment, a single serving of dairy powder (about 3 grams) has about 100 mg of calcium mineral.

The dairy powders of the present invention may be dry blended with other comestibles (food or food grade or ingredients) packaged along with other food products, for example, pasta, rice and the like. The consumer may cook the food products separately and prepare a sauce using the dairy powder and combine the food and the sauce for obtaining an edible food product fortified with calcium and superior taste. Alternatively, the food product and the dairy powder may be combined and cooked together to make the final edible product. A number of variations of obtaining the final product are known in the art and are all within the scope of this invention.

### EXAMPLE 1

Table 1 indicates the ingredients used to make cheese powder. The ingredients listed below are used and processed according to the method shown in FIG. 1.

TABLE 1

| | | Cheese powder | Cheese powder |
|---|---|---|---|
| | | w/out Aquamin ® F | with Aquamin ® F |
| Vendor Name | Ingredient | % as is | % as is |
| Land O'Lakes, Inc., | 510#V CHED, | 26.09 | 26.05 |
| Arden Hills, MN | BRL 31-45 | | |
| | Day, Corr | | |
| Janeil Biotech, Inc. | EMC, Cheddar | 7.91 | 7.90 |
| Saukville, WI | ch 5054 | | |
| CHS Inc. | Soy oil, Part. | 12.70 | 12.68 |
| Mankato, MN | Hyd. HM 508, | | |
| | TNKR | | |
| Land O'Lakes, Inc. | 50 LB Extra | 17.71 | 17.68 |
| Arden Hills, MN | Grade Sweet | | |
| | Whey | | |
| Wapsie Valley | Whey, Dry, | 18.59 | 9.83 |
| Creamery, Inc. | Reduced | | |
| Independence, | Lactose | | |
| IA | | | |
| GTC Nutrition (Corn | Aquamin ® F | 0.00 | 8.90 |
| Products | | | |
| International, Inc.) | | | |
| Golden, CO | | | |
| Grain Processing | Maltodextrin, | 7.36 | 7.35 |
| Corporation | Maltrin M100 | | |
| Muscatine, IA | | | |
| ICL Performance | Phosphate, | 2.98 | 2.97 |
| Products LP | Disodium Dry, | | |
| Lawrence, KS | 50# | | |
| Cargill, Incorporated | Salt, CMF Evap | 5.38 | 5.37 |
| Wayzata, MN | W/YPS, 2000# | | |
| Brenntag Great | Citric Acid 50 lb | 0.89 | 0.89 |
| Lakes, LLC | BG | | |
| Butler, WI | | | |
| Sensient | FD &C Yellow | 0.13 | 0.13 |
| Technologies | #5 | | |
| Corporation | | | |
| St. Louis, MO | | | |
| Sensient | FD &C Yellow | 0.13 | 0.13 |
| Technologies | #6 CAL STB | | |
| Corporation | | | |
| St. Louis, MO | | | |
| Chr. Hanson, Inc. | A-400-S, 400LB | 0.11 | 0.11 |
| Milwaukee, WI | | | |
| | TOTAL | 100.00 | 100.00 |

In this exemplary preparation, 8.9 grams of the Aquamin®F was used for preparation of 100 grams of the dairy powder. Aquamin®F, generally contains about 31-33% of calcium mineral, thus, about 3 grams of calcium mineral is present in a 100 gram preparation of dairy powder.

The recommended daily intake (RDI) for calcium for an adult is generally about 1000 mg. A single serving of the dairy powder is about 3 grams. A 3 gram amount of the dairy powder of Table 1 contains about 0.267 grams or 267 milligrams of added Aquamin®F. A single 3 gram serving of the dairy powder, therefore, contains about 89 mg of incorporated calcium mineral.

The sensory results from the calcium fortified cheese powder were surprisingly positive. The calcium fortified cheese powder was found in sensory panels to be close in flavor to the control product without any added calcium and much more favorable than cheese powder in which the calcium was dry blended.

Although the present invention has been described with reference to preferred embodiments, workers skilled in the art will recognize that changes may be made in form and detail without departing from the spirit and scope of the invention.

What is claimed is:

1. A method of fortifying a dairy powder with calcium comprising:
adding a calcium source to a slurry in a slurry tank, the slurry comprising
dairy powder and the calcium source comprising a porous, lattice type structure;
processing the slurry for atomization; and
spray drying the slurry using nozzles to form a powder.

2. The method of claim 1 further comprising:
allowing the powder to fall onto a fluid bed wherein additional moisture is removed; and
partially cooling the powder.

3. The method of claim 1 wherein the processing comprises:
heating slurry in the slurry tank;
transferring the slurry to a surge tank;
pumping the slurry through a high pressure pump; and
homogenizing by using a homogenizer.

4. The method of claim 1 wherein the spray drying further comprises using a tower spray dryer.

5. The method of claim 1 wherein the dairy powder is dry blended with comestibles.

6. The method of claim 1 wherein the calcium source is derived from seaweed calcium.

7. The method of claim 1 wherein the calcium source is produced from at least one of the seaweed Phymatolithon and Lithothamnion.

8. The method of claim 1 wherein the powder produced is characterized by having a flavor in parity with product having no added calcium.

9. The method of claim 3 wherein the slurry is heated to about 140° F. and about 170° F.

10. The method of claim 1 wherein the calcium source is at least about 5% by weight of the dairy powder.

11. The method of claim 1 wherein the calcium source is between about 5% by weight and about 40% by weight of the dairy powder.

12. The method of claim 1 wherein one serving of the dairy powder comprises at least about 5% of the recommended daily intake of calcium.

13. The method of claim 1 wherein one serving of the dairy powder comprises at least about 10% of the recommended daily intake of calcium.

14. The method of claim 1 wherein one serving of the dairy powder comprises at least about 20% of the recommended daily intake of calcium.

15. The method of claim 1 wherein one serving of the dairy powder comprises at least about 30% of the recommended daily intake of calcium.

16. The method of claim 1 wherein the slurry further comprises additional ingredients comprising fillers, acidulants, flavors, emulsifiers or combinations thereof.

17. A method of incorporating calcium into a food powder comprising:
adding food powder and a calcium source to a slurry in a slurry tank;
processing the slurry for atomization; and
spray drying the slurry using nozzles to form a powder wherein each serving of food powder comprises greater than about 5% of the recommended daily intake of calcium.

18. The method of claim 17 wherein the food powder is a dairy powder.

19. The method of claim 17 wherein the calcium source has a porous lattice type structure.

20. The method of claim 17 wherein the food powder is characterized by having a flavor in parity with product having no added calcium.

21. A food powder comprising spray dried particles of calcium and dairy powder wherein the calcium source has a porous, lattice type structure.

22. The food powder of claim 21 wherein the particles are further dried.

23. The food powder of claim 21 wherein the calcium source is derived from seaweed calcium.

24. The food powder of claim 21 wherein the powder is characterized by having a flavor in parity with a powder having no added calcium.

25. The food powder of claim 21 wherein the dairy powder is a cheese powder.

26. The food powder of claim 21 wherein the powder is dry blended with other ingredients.

27. The food powder of claim 21 wherein one serving of the food powder comprises at least about 5% of the recommended daily intake of calcium.

28. The food powder of claim 21 wherein one serving of the food powder comprises at least about 10% of the recommended daily intake of calcium.

29. The food powder of claim 21 wherein one serving of the food powder comprises at least about 20% of the recommended daily intake of calcium.

30. The food powder of claim 21 wherein one serving of the food powder comprises at least about 30% of the recommended daily intake of calcium.
